(19) United States
(12) Patent Application Publication
(10) Pub. No.: US 2021/0069956 A1
(43) Pub. Date: Mar. 11, 2021

(54) INJECTION MOLDING MACHINE

(71) Applicant: SODICK CO., LTD., KANAGAWA (JP)

(72) Inventors: Yoshitaka HOSOTSUBO, Kanagawa (JP); Keisei KUMAMOTO, Kanagawa (JP)

(73) Assignee: SODICK CO., LTD., KANAGAWA (JP)

(21) Appl. No.: 17/008,654

(22) Filed: Sep. 1, 2020

(30) Foreign Application Priority Data
Sep. 5, 2019 (JP) 2019-161760

(51) Int. Cl. B29C 45/76

(52) U.S. Cl. CPC B29C 45/762; B29C 45/7626; B29C 2945/76464; B29C 2945/76939; B29C 2945/76394; B29C 2945/76418; B29C 2945/76381; B29C 2945/76384; B29C 2945/76391; B29C 2045/7606

(57) ABSTRACT

An injection molding machine which includes a mold clamping device (20) that opens and closes a mold (90) and clamps the closed mold, an injection device (30) that injects a material into the clamped mold, and an ejecting device (21) that ejects a molded product (100) molded in the mold is provided. The injection molding machine further includes a plurality of cameras (2) that photograph the injection molding machine to generate image data, a memory (6) that records the image data, an input device that sets at least one photographing time by selecting the start or end of each process in a molding cycle, and a control device that controls the camera to photograph the injection molding machine at the at least one photographing time, and controls the memory to record the image data.

### CROSS-REFERENCE TO RELATED APPLICATION

This application claims the priority of Japan patent application serial no. 2019-161760, filed on Sep. 5, 2019. The entirety of the above-mentioned patent application is hereby incorporated by reference herein and made a part of this specification.

### BACKGROUND

### Technical Field

The disclosure relates to an injection molding machine which injects a material into a mold cavity to form a molded product. The disclosure particularly relates to an injection molding machine which includes a mold clamping device that opens and closes a mold and clamps the closed mold, an injection device that injects a material into the clamped mold, and an ejecting device that ejects a molded product molded in the mold.

### Related Art

Generally, an injection molding machine includes a mold clamping device, an injection device, and a main control device that controls the mold clamping device and the injection device. The mold clamping device closes and clamps the mold. The injection device injects a material into a mold cavity. The material is solidified in the mold cavity, and a molded product is formed. The mold clamping device opens the mold, and the ejecting device ejects the molded product.

The main control device controls the mold clamping device and the injection device in order to repeat the above molding cycle. Various detectors are mounted on the mold clamping device and the injection device, and output signals of the detectors are supplied to the main control device. When the main control device detects an abnormality in the above devices based on the output signals of the detectors, the main control device stops the injection molding machine.

Japanese patent No. 4138694 discloses a mold monitoring system in which a mold cavity of an opened mold is photographed by a camera. When the mold monitoring system detects that the molded product adheres to the mold cavity unintentionally, the mold monitoring system stops the operation of the molding machine. The mold monitoring system records the data of the photographed image in a memory in association with shot numbers.

Most injection molding machines detect the maximum value of an injection pressure and the molding cycle, and it is desired to minimize the variation of the above detection values. It is desired that when an abnormality of the injection molding machine is detected, the operator changes molding conditions to quickly eliminate the abnormality. It is desired that the injection molding machine minimizes molding defects such as short shot, burr, sink mark and the like.

### SUMMARY

The disclosure provides an injection molding machine in which a plurality of cameras are used to photograph the injection molding machine at a suitable photographing time, and the image data are recorded in the memory in order to quickly elucidate the cause of an abnormality of the injection molding machine, variation of the detection value for each molding cycle and molding defects. The suitable photographing time is selected from the start or end of each of a plurality of processes which constitute the molding cycle.

The disclosure relates to an injection molding machine which includes a mold clamping device that opens and closes a mold and clamps the closed mold, an injection device injects a material into the clamped mold, and an ejecting device that ejects a molded product molded in the mold. The injection molding machine further includes a plurality of cameras arranged to photograph the injection molding machine, a memory, a display device, and a control device that causes the display device to display a selection screen for selecting at least one photographing time from a plurality of photographing times, controls the camera to photograph the injection molding machine at the at least one photographing time to generate image data, controls the memory to record the image data, and causes the display device to display the image data. The plurality of photographing times are selected from: start of a mold closing process in which the mold clamping device closes the mold, end of the mold closing process, start of a mold clamping process in which the mold clamping device tightens the closed mold, end of the mold clamping process, start of a weighing process in which the injection device weighs the material, end of the weighing process, start of an injection process in which the injection device injects the material into the mold, end of the injection process, start of a pressure holding process in which the injection device maintains a holding pressure with respect to the material in the mold, end of the pressure holding process, start of a cooling process in which the material in the mold is cooled and solidified as the molded product, end of the cooling process, start of a mold opening process in which the mold clamping device opens the mold, end of the mold opening process, start of an ejecting process in which the ejecting device ejects the molded product formed in the mold, and end of the ejecting process.

### BRIEF DESCRIPTION OF THE DRAWINGS

FIG. 1 is a front view showing an image recording device and an injection molding machine.

FIG. 2 is a front view showing the image recording device and the injection molding machine.

FIG. 3 is a plan view showing the image recording device, the injection molding machine and auxiliary devices.

FIG. 4 is a diagram showing an example of a selection screen displayed by a display device.

### DESCRIPTION OF THE EMBODIMENTS

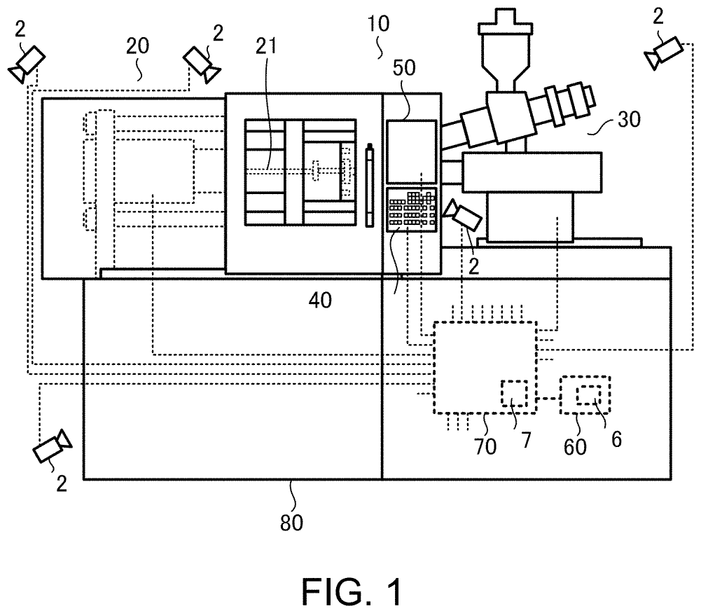

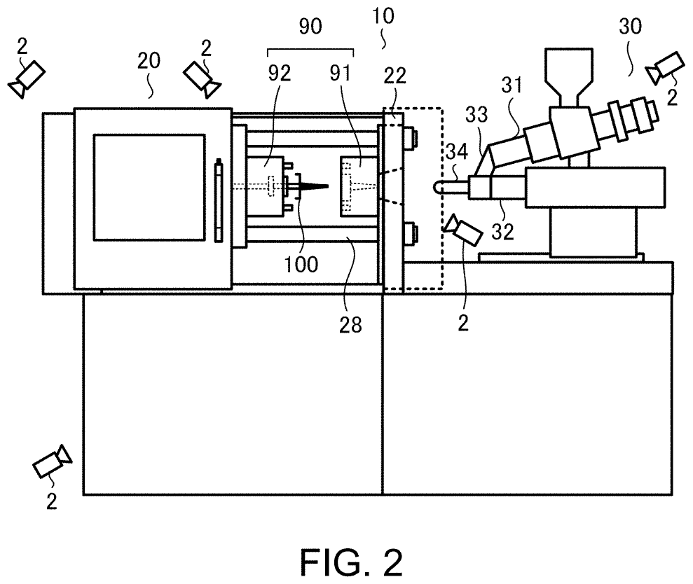

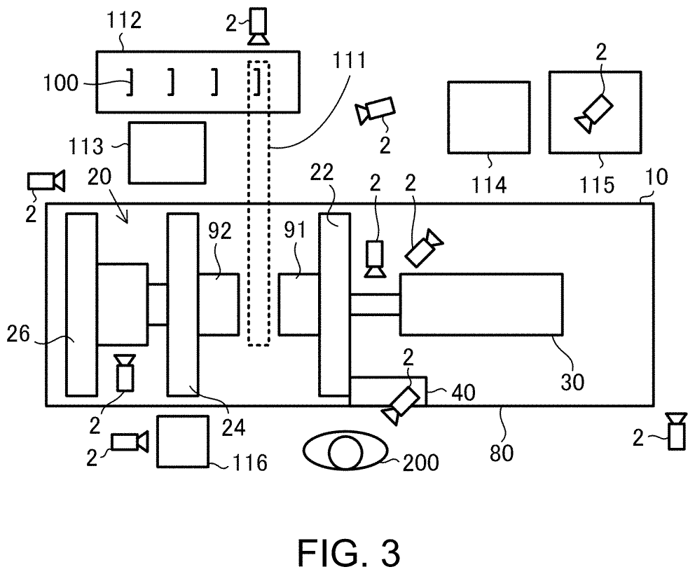

Hereinafter, embodiments of the disclosure are described in detail with reference to the drawings. As shown in FIG. 1, FIG. 2 and FIG. 3, an injection molding machine 10 includes a mold clamping device 20, an injection device 30, a main control device 70 for controlling the mold clamping device 20 and the injection device 30, a main memory 60, a main display device 50, and an operation panel 40. The mold clamping device 20 and the injection device 30 are arranged on a base platform 80. A mold 90 including a fixed mold 91 and a movable mold 92 is mounted on the mold clamping device 20.

Generally, the material of a molded product is a thermoplastic resin, a thermosetting resin, or a light metal. The injection molding machine 10 injects the thermoplastic resin, which is a typical material, into a mold cavity. The mold clamping device 20 includes a fixed platen 22, a movable platen 24, a rear platen 26, a plurality of tie bars 28, a mold opening/closing drive device, a mold clamping drive device, and an ejecting device 21.

The plurality of tie bars 28 connect the fixed platen 22 and the rear platen 26. The movable platen 24 is arranged between the fixed platen 22 and the rear platen 26 to be moveable along the plurality of tie bars 28. The fixed mold 91 is mounted on the fixed platen 22, and the movable mold 92 is mounted on the movable platen 24. The mold cavity is formed in the mold 90 that has been clamped. The mold opening/closing drive device and the mold clamping drive device are mounted on the rear platen 26. Drive shafts of the mold opening/closing drive device and the mold clamping drive device are mounted on the movable platen 24.

The mold opening/closing drive device has, for example, a ball screw mechanism and a rotation motor, and largely moves the movable platen 24 in order to open and close the mold 90. A pressure applied to the movable platen 24 can be detected by, for example, measuring a current flowing through the rotation motor. The pressure applied to the movable platen 24 may be detected by a pressure detector such as a load cell.

The mold clamping drive device has, for example, a hydraulic actuator, and directly applies a large pressure to the movable platen 24 when clamping the mold 90. The pressure with which the mold 90 is tightened can be detected by, for example, a pressure detector arranged in the hydraulic actuator. Alternatively, the pressure detector such as a load cell may detect the pressure with which the mold 90 is tightened.

The ejecting device 21 has an ejector pin, an ejector rod, and an ejector rod drive device. The ejector pin is mounted on the movable mold 92. The ejector rod and the ejector rod drive device are mounted on the movable platen 24. The ejector rod drive device has a ball screw and a rotation motor and advances the ejector rod. By the advance of the ejector rod, the ejector pin ejects a molded product 100, and the molded product 100 is separated from the movable mold 92. The position of the ejector rod is detected by a position detector such as a rotary encoder.

The injection device 30 includes a plasticizing cylinder 31, an injection cylinder 32, a connection part 33, and a backflow prevention device. The injection device 30 includes a plasticizing screw, a screw rotation drive device, and heaters. The plasticizing screw is arranged in the plasticizing cylinder 31 to rotate freely and to advance and retract freely. The screw rotation drive device has, for example, a hydraulic motor, and rotates the plasticizing screw. The rotation speed of the plasticizing screw is detected by, for example, a rotation detector such as a rotary encoder.

The heaters are, for example, a plurality of band heaters wound around the outer periphery of the plasticizing cylinder 31. The outer periphery of the plasticizing cylinder 31 is divided into a plurality of zones in the longitudinal direction, and the plurality of zones are heated by each of the band heaters. The temperature of each zone of the plasticizing cylinder 31 is detected by, for example, a temperature detector such as a thermocouple. The material supplied into the plasticizing cylinder 31 is melted by the rotation of the plasticizing screw in addition to the heating of the heaters.

The connection part 33 connects the plasticizing cylinder 31 and the injection cylinder 32. The connection part 33 has a communication passage that connects the interior of the plasticizing cylinder 31 and the interior of the injection cylinder 32. A melted resin in the plasticizing cylinder 31 is sent to the front end of the plasticizing screw, and further sent to the interior of the injection cylinder 32 through the communication passage. The injection device 30 includes an injection nozzle 34, an injection member, an injection member drive device, and heaters. The injection nozzle 34 is mounted on the front end of the injection cylinder 32. As the injection member, a plunger is arranged in the injection cylinder 32 to advance and retract freely. Instead of the plunger, a screw may be arranged in the injection cylinder 32 to rotate freely and to advance and retract freely. The injection member drive device has, for example, a hydraulic actuator, and causes the plunger to advance and retract.

The pressure applied to the plunger can be detected by, for example, a pressure detector arranged in the hydraulic actuator. Alternatively, a pressure detector such as a load cell arranged between the plunger and the injection member drive device may detect the pressure applied to the plunger. The position of the plunger is detected by a position detector such as a linear encoder.

The heaters are a plurality of band heaters wound around the outer periphery of the injection cylinder 32. The band heaters are also wound around the outer periphery of the injection nozzle 34. The outer periphery of the injection cylinder 32 is divided into a plurality of zones in the longitudinal direction, and the plurality of zones are heated by each of the band heaters. The temperature of each zone of the injection cylinder 32 and the temperature of the injection nozzle 34 are detected by, for example, by a temperature detector such as a thermocouple.

The melted resin flows into the injection cylinder 32 while pushing the plunger backward until the plunger retracts to a predetermined position. The melted resin is measured by the retracted position of the plunger. When the plunger retracts, a back pressure from the front and smaller than the pressure of the melted resin is applied to the plunger.

The backflow prevention device opens and closes the communication passage. The backflow prevention device has, for example, a screw-advancing drive device, and advances the plasticizing screw to close an opening of the communication passage on the plasticizing cylinder 31 side. The screw-advancing drive device has, for example, a single acting hydraulic actuator, and advances the plasticizing screw that is not rotating with a hydraulic pressure. The backflow prevention device may be a check valve or a rotary valve that opens and closes the communication passage.

The operation panel 40 has operation keys for an operator 200 to operate the injection molding machine 10. The operation panel 40 has input keys for the operator 200 to input settings of the injection molding machine 10 including molding conditions. The main display device 50 displays at least the settings. The main display device 50 may have a transparent touch panel superimposed on a display screen and include input keys. The touch panel may be included in the operation panel 40. The main memory 60 records at least the settings.

The main control device 70 controls the mold clamping device 20 and the injection device 30 based on the settings which include the molding conditions. The main control device 70 controls, for example, the mold opening/closing drive device, the mold clamping drive device, the screw rotation drive device, the screw-advancing drive device, the injection member drive device, the ejector rod drive device, and the heaters, based on the settings. The main control device 70 receives at least detection values which are output from the temperature detector, the rotation detector, the pressure detector and the position detector.

The main control device 70 controls the injection molding machine 10 to repeat a molding cycle which starts in a mold closing process and ends by the start of the next mold closing process. In the mold closing process, the mold clamping device 20 closes the mold 90. In the mold closing process, a mold closing speed is preferentially controlled. The mold closing speed is represented by a speed at which the movable platen 24 moves toward the fixed platen 22. In a mold opening process, a mold opening speed is preferentially controlled. The mold opening speed is represented by a speed at which the movable platen 24 moves toward the rear platen 26.

In a mold clamping process, the mold clamping device 20 clamps the mold 90. In an injection process, the injection device 30 injects the melted resin into the mold. In the injection process, an injection speed is preferentially controlled. The injection speed is represented by a speed at which the plunger advances. An injection pressure is represented by the pressure applied to the plunger during the injection process. When the injection pressure gradually increases and reaches a velocity pressure (VP) switching pressure in the injection process, the injection process shifts to a pressure holding process. Alternatively, when the position of the plunger reaches a VP switching position, the injection process shifts to the pressure holding process.

In the pressure holding process, the injection device 30 maintains a holding pressure with respect to the melted resin filled in the mold cavity by the injection process. In the pressure holding process, the holding pressure is preferentially controlled. The holding pressure is represented by the pressure in the advancing direction of the plunger that is applied to the plunger during the pressure holding process. In the pressure holding process, the holding pressure is applied to the melted resin in the mold through the melted resin remaining in the injection cylinder 32. The pressure holding process fills insufficient amount of the melted resin caused by a heat-shrink of the melted resin in the mold.

In a cooling process after the holding pressure is released, the melted resin in the mold is cooled and solidified to form the molded product 100. In the mold opening process, the mold clamping device 20 opens the mold 90. In an ejecting process, the ejecting device 21 ejects the molded product 100 from the mold 90. From the cooling process to the mold clamping process, a weighing process which weighs the melted resin in the injection cylinder 32 is performed.

Various detectors are arranged in the mold clamping device 20 and the injection device 30. The detectors are, for example, the temperature detector, the rotation detector, the pressure detector, and the position detector. An emergency stop button for the operator 200 is also included in the detectors. The main control device 70 is configured to receive the output of the detectors, and detects an abnormality of the mold clamping device 20 and the injection device 30 based on the output of the detectors. A signal showing that the operator 200 has pressed the emergency stop button is also included in the above output. The main control device 70 stops the injection molding machine 10 or causes the main memory 60 to record that the molded product 100 is a defective product according to the abnormality.

The temperature detector detects the temperatures of the plasticizing cylinder 31, the injection cylinder 32, the injection nozzle 34 and the connection part 33, respectively. The rotation detector detects the rotation speed of the plasticizing screw. The pressure detector detects the pressure applied to the plunger and the movable platen 24. The position detector detects the positions of the plunger and the movable platen 24, respectively.

The main control device 70 monitors the molding conditions based on the output of the detectors. The molding condition is, for example, the temperature of each part. The main control device 70 controls ON/OFF of the band heaters according to the output of the temperature detector to maintain the temperatures of the plasticizing cylinder 31, the injection cylinder 32, the injection nozzle 34 and the connection part 33 at set values. The molding conditions include the molding cycle, a screw rotation speed, a weighing completion position, a weighing time, the back pressure, an injection time, a VP switching pressure, a VP switching position, a maximum filling pressure, a minimum cushion amount, a final cushion amount, a filling rate and a mold closing time.

The screw rotation speed is a rotation speed per minute of the plasticizing screw. The main control device 70 completes the weighing when the plunger retreats and reaches the weighing completion position. The weighing completion position defines the volume of the melted resin for one shot. The weighing time is a duration time from the start of the weighing to the completion of the weighing. The back pressure is a pressure applied to the plunger in order to suppress a sudden retreat during the weighing.

The injection time is a duration time from the start of the injection process to the VP switching. The VP switching pressure is an injection pressure during the VP switching. The VP switching position is a position of the plunger during the VP switching. The maximum filling pressure is the maximum pressure applied to the plunger from the start of the injection process to the end of the pressure holding process. A cushion amount shows the amount of the resin remaining in the injection cylinder 32 in front of the plunger in the injection process and the pressure holding process. The minimum cushion amount is represented by the most advanced position of the plunger from the start of the injection process to the end of the pressure holding process. The final cushion amount is represented by the position of the plunger when the pressure holding process ends. The filling rate is calculated by dividing the distance from the weighing completion position to the VP switching position with the distance from the weighing completion position to the minimum cushion amount. The mold closing time is the time of the mold closing process.

An allowable range of the molding condition is set by, for example, the maximum value and the minimum value. The main control device 70 determines that the injection molding machine 10 has an abnormality when the detection value of the molding condition is out of the allowable range. The main control device 70 may determine that the injection molding machine 10 has an abnormality when the moving average of the molding condition is out of the allowable range. The molded product 100 manufactured in the duration determined to have an abnormality is regarded as a defective product.

As shown in FIG. 3, the injection molding machine 10 may include auxiliary devices such as a take-out device 111, an insert device, a conveying device 112, a crushing device 113, a material supply device 114, a material drying device 115, a gas suction device, a clamp device and a temperature adjustment device 116. The main control device 70 may receive various detection signals output from the auxiliary devices. The main control device 70 determines an abnormality of the auxiliary devices based on the detection signals. According to the content of the abnormality, the main control device 70 stops the injection molding machine 10 and the auxiliary devices, or causes the main memory 60 to record the molded product 100 molded at the time of abnormality as a defective product.

The take-out device 111 takes out the molded product 100 from the mold 90 that is opened. The insert device mounts an insert component on the mold 90 that is opened. The conveying device 112 is a chute or a belt conveyor that conveys the molded product 100 taken out from the mold 90. The crushing device 113 crushes unnecessary parts of the molded product 100 for recycling. The material supply device 114 supplies the material to the plasticizing cylinder 31 of the injection device 30. The material drying device 115 dries the material before being supplied to the injection device 30. The gas suction device is a vacuuming device and sucks undesired gases generated in the injection device 30 or the mold 90. The clamp device is a magnet clamp and fixes the mold 90 to the mold clamping device 20. The temperature adjustment device 116 adjusts the mold 90 to a desired temperature using a heated or cooled fluid or the heaters.

The injection molding machine 10 includes an image recording device that records the data of the image obtained by photographing the injection molding machine 10. The image recording device includes a plurality of cameras 2 which photograph the injection molding machine 10, a memory 6, a control device 7 and a display device 5. Five cameras 2 are illustrated in FIG. 1 and FIG. 2, and ten cameras 2 are illustrated in FIG. 3.

The control device 7 causes the memory 6 to record the data of the image photographed by the cameras 2 every time the photographing time arrives. In this way, the data of a plurality of images is recorded in the memory 6. The control device 7 reads out the data of one image from the data of a plurality of images recorded in the memory 6 and displays the readout data on the display device 5. The control device 7 may read out the data of two or more images and display the data of the images at the same time on the display device 5.

The camera 2 includes an imaging component such as a CCD component, a CMOS component or the like. As shown in FIG. 1 to FIG. 3, the camera 2 is arranged at a position where a specific portion of the injection molding machine 10 can be photographed. The camera 2 may be arranged at a position where the whole of the injection molding machine 10 can be photographed. The camera 2 may be arranged at a position where the interior of the injection molding machine 10 can be photographed.

The camera 2 may be arranged at a position where the auxiliary devices of the injection molding machine 10 can be photographed. The camera 2 may be arranged at a position where the molded product 100 being conveyed by the conveying device 112 can be photographed, or at a position where the operator 200 can be photographed. The camera 2 may be mounted on the injection molding machine 10 or the auxiliary devices. The camera 2 may be mounted on, for example, a support member such as a tripod, or may be mounted above the injection molding machine 10, for example, on a ceiling.

The memory 6 records the data of the images photographed by the camera 2. The memory 6 may be included in the main memory 60 of the injection molding machine 10. The memory 6 can record the data of at least one image. Further, the memory 6 may record the photographing time that is set. The image recording device may include an input device 4 which sets the photographing time. The input device 4 may be included in the operation panel 40 of the injection molding machine 10.

The control device 7 controls the camera 2 to photograph an object at the photographing time that is set. The control device 7 controls the memory 6 to record the data of the image photographed by the camera 2. The control device 7 may have a function of generating the data of the image from a signal output from the imaging component included in the camera 2. The control device 7 receives a signal showing the detection of an abnormality of the mold clamping device 20 or the injection device 30 from the main control device 70. The control device 7 may be included in the main control device 70 of the injection molding machine 10. The control device 7 controls the camera 2 to photograph at a time delayed from the photographing time by a delay time that is set. The delay time is set from a range of 0.1 to 999.9 seconds, for example.

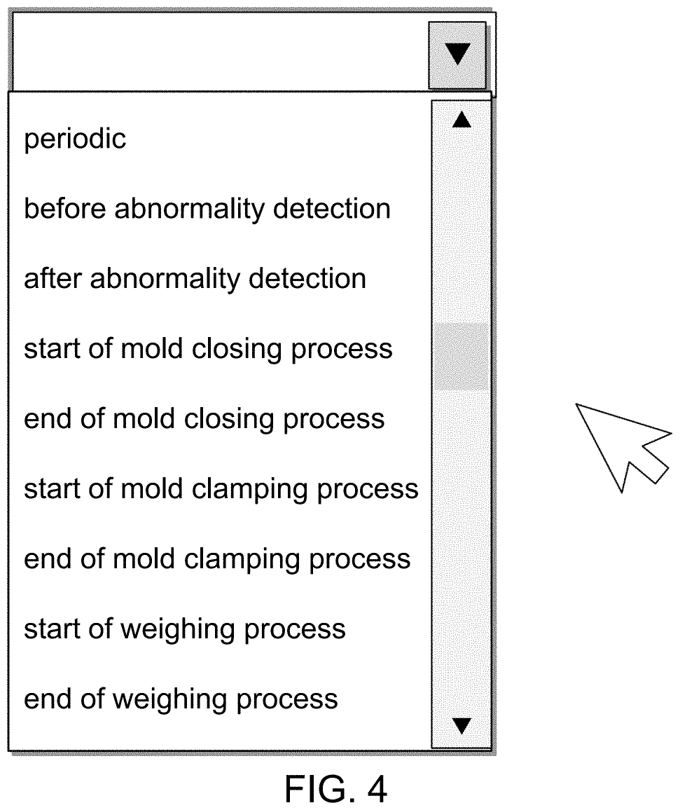

The display device 5 displays a selection screen as illustrated in FIG. 4. The operator 200 uses the selection screen to set at least one photographing time from multiple photographing times. It is also possible to set a plurality of photographing times. When “periodic” is set as the photographing time, the operator 200 can further set a period from a range of 0.1 to 999.9 seconds. The operator 200 can set “after abnormality detection” as the photographing time. In this case, the control device 7 controls the camera 2 to photograph the object for a predetermined duration from the abnormality detection.

The operator 200 can set the time “before abnormality detection” as the photographing time. In this case, the control device 7 controls the camera 2 to photograph the object at a predetermined period until the abnormality detection. The control device 7 controls the memory 6 to sequentially record the data of a plurality of images and delete the data of old images. The old image to be deleted is, for example, an image photographed before the photographing of a latest image by the predetermined duration. For example, the control device 7 causes the camera 2 to photograph at an interval of one second and controls the memory 6 to delete the data of the old image photographed 11 seconds before the photographing of the latest image. Alternatively, when the number of recorded images exceeds a predetermined number, the data of the oldest image is deleted. For example, the control device 7 causes the camera 2 to photograph at an interval of one second and controls the memory 6 to delete the data of the oldest image when the number of recorded images exceeds 10.

The operator 200 can set the photographing time by using the selection screen in FIG. 4 to select the start or end of a plurality of processes in the molding cycle. That is, as the photographing time, at least one of the following is selected: “start of mold closing process”, “end of mold closing process”, “start of mold clamping process”, “end of mold clamping process”, “start of injection process”, “end of injection process”, “start of pressure holding process”, “end of pressure holding process”, “start of mold opening process”, “end of mold opening process”, “start of ejecting process” and “end of ejecting process”. In general, the “end of mold closing process” is at the same time as the “start of mold clamping process”, and the “end of injection process” is at the same time as the “start of pressure holding process”.

Further, the operator 200 can look at the selection screen in FIG. 4 to select “start of purge”, “end of purge”, “start of material replacement” and “end of material replacement” as the photographing time. The purge is an operation of discharging the resin remaining in the injection cylinder 32 by advancing the injection member in a state that the injection nozzle 34 is not in contact with the mold. The main purpose of the purge is cleaning and the material replacement. The material replacement is to replace the old material remaining in the injection cylinder 32 with a new material, and usually includes a plurality of times of the purges.

The operator 200 can select the photographing time by looking at the selection screen in FIG. 4 to select “completion of production” and further specifying the number of the molded product. In this case, the completion of the production of the set number of molded products is set as the photographing time. The photographing time may be the time when the operator 200 manually operates a photographing key. The photographing key is an operation key which is arranged on the input device 4 and causes the camera 2 to start to photograph. The operation key may be arranged on the operation panel 40 or the touch panel of the injection molding machine 10. At least one of a plurality of different photographing times may be selected. Different photographing times may be set for a plurality of the cameras 2.

The control device 7 may control the memory 6 to record additional information in association with the image. The additional information may include at least one of a photographing date and time, a shot count during photographing, setting of the photographing time, setting of the delay time, the type of the camera 2 that photographed the image, and the type of the injection molding machine 10. The shot count is a serial number of the molding cycle, and shows “n” in the n-th molding cycle. The information about the photographing time may include the content of the abnormality of the injection molding machine 10.

The display device 5 displays the data of the image. The display device 5 may be included in the main display device 50 of the injection molding machine 10. The control device 7 controls the memory 6 to read out the image data recorded in the memory 6, and controls the display device 5 to display the image data that is read out. Alternatively, the control device 7 may control a buffer memory to temporarily record the data of the image photographed by the camera 2, and may control the display device 5 to display the image data read out from the buffer memory. The control device 7 controls the memory 6 to record the image data read out from the buffer memory when necessary.

The control device 7 may control the display device 5 to display together the data of each of the images photographed by the plurality of cameras 2. The control device 7 may control the display device 5 to simultaneously display the data of the image and the additional information related to the image. The additional information may be included in the data of the image.

When the time “before abnormality detection” or the time “after abnormality detection” is set as the photographing time, the control device 7 controls the memory 6 to record the date and time when the abnormality is detected and the operation in which the operator 200 changes the setting of the molding conditions in order to remove the abnormality. The control device 7 controls the display device 5 to display the date and time when the abnormality is detected and the change of the setting of the molding conditions together with the data of the image. The injection molding machine 10 may include a data output device (not shown) which connects a network line or a recording medium. The control device 7 may use the network line or the recording medium to output the data of the image to the outside.

The illustrated embodiment has been chosen in order to best explain the principles of the disclosure and its practical application. It is intended that the scope of the disclosure be defined by the claims appended hereto.

What is claimed is:

1. An injection molding machine, comprising a mold clamping device that opens and closes a mold and clamps the closed mold, an injection device that injects a material into the clamped mold, and an ejecting device that ejects a molded product molded in the mold,
wherein the injection molding machine further comprises a plurality of cameras arranged to photograph the injection molding machine,
a memory,
a display device, and
a control device that causes the display device to display a selection screen for selecting at least one photographing time from a plurality of photographing times, controls the camera to photograph the injection molding machine at the at least one photographing time to generate data of an image, controls the memory to record the data of the image, and causes the display device to display the data of the image, wherein
the plurality of photographing times are selected from a group of following times:
start of a mold closing process in which the mold clamping device closes the mold,
end of the mold closing process,
start of a mold clamping process in which the mold clamping device tightens the closed mold,
end of the mold clamping process,
start of a weighing process in which the injection device weighs the material,
end of the weighing process,
start of an injection process in which the injection device injects the material into the mold,
end of the injection process,
start of a pressure holding process in which the injection device maintains a holding pressure with respect to the material in the mold,
end of the pressure holding process,
start of a cooling process in which the material in the mold is cooled and solidified as the molded product,
end of the cooling process,
start of a mold opening process in which the mold clamping device opens the mold,
end of the mold opening process,
start of an ejecting process in which the ejecting device ejects the molded product formed in the mold, and
end of the ejecting process.

2. The injection molding machine according to claim 1, wherein the plurality of photographing times include a time before abnormality detection, and
the control device is configured to receive a signal showing detection of an abnormality of the injection molding machine, and controls the camera to photograph at a predetermined period until the detection of the abnormality when the time before abnormality detection is selected as the photographing time.

3. The injection molding machine according to claim 2, wherein the control device controls the memory and the display device to record a date and time when the abnormality is detected and a change of molding conditions for removing the abnormality, and to display the record together with the data of the image.

4. The injection molding machine according to claim 1, wherein the plurality of photographing times include a time after abnormality detection, and
the control device is configured to receive a signal showing detection of an abnormality of the injection molding machine, and control the camera to photograph for a predetermined duration from the detection of the abnormality when the time after abnormality detection is selected as the photographing time.

5. The injection molding machine according to claim 4, wherein the control device controls the memory and the display device to record a date and time when the abnormality is detected and a change of molding conditions for removing the abnormality, and to display the record together with the data of the image.

6. The injection molding machine according to claim 1, wherein the injection device includes an injection cylinder, an injection member arranged in the injection cylinder to advance and retract freely, and an injection nozzle mounted on a front end of the injection cylinder, and
the plurality of photographing times are selected from either start of a purge or end of the purge, wherein the purge is to discharge the material remaining in the injection cylinder by advancing the injection member while the injection nozzle is not in contact with the mold.

7. The injection molding machine according to claim 6, wherein the plurality of photographing times are selected from either start of a material replacement or end of the material replacement, wherein the material replacement is to replace the material in the injection cylinder with an other material by a plurality of times of the purge.

8. The injection molding machine according to claim 1, wherein the control device controls the memory to record additional information related to the image; and
wherein the additional information includes at least one of a photographing date and time, a shot count during photographing, a setting of the photographing time, a type of the camera that photographed the image and a type of the injection molding machine.

9. The injection molding machine according to claim 8, wherein the control device controls the display device to simultaneously display the data of the image and the additional information.
